(19) United States
(12) Patent Application Publication
(10) Pub. No.: US 2012/0124075 A1
(43) Pub. Date: May 17, 2012

(54) APPLICATION INDEPENDENT DOCUMENT SUBMISSION FOR SYSTEM INTEROPERABILITY

(75) Inventor: Anthony P. Galluscio, Indialantic, FL (US)

(73) Assignee: Harris Corporation, Melbourne, FL (US)

(21) Appl. No.: 12/944,285

(22) Filed: Nov. 11, 2010

(51) Int. Cl. G06F 7/10; G06F 17/30

(52) U.S. Cl. 707/769; 707/E17.014

(57) ABSTRACT

Systems (100) and methods (400) for providing interoperability between Computing Systems (CSs) employing software applications implementing different standards. At a first CS (112), an electronic document (602) is generated. The first CS is operative to: receive a first user input selecting a second CS (124, 130, 136, 160) that is to receive data contained in the electronic document; automatically select one or more templates from a plurality of pre-defined templates based on the first user input; automatically complete the template using data contained in the electronic document; automatically obtain pre-defined metadata specifying a meaning of information contained in the template and an intended use of the information; and communicate the pre-defined metadata and the template to the second CS. Notably, the completed template has a second data structure that is different than the first data structure and with which the second CS is compatible.

### BACKGROUND OF THE INVENTION

1. Statement of the Technical Field

The inventive arrangements relate to data processing systems, and more particularly to systems and methods for providing interoperability between a plurality of different data processing systems (e.g., healthcare systems).

2. Description of the Related Art

There are many conventional data processing systems known in the art. These conventional data processing systems are diverse systems that are often unable to work together, i.e., they are not interoperable. The term “interoperable”, as used herein, refers to syntactic interoperability and semantic interoperability. The phrase “syntactic interoperability” refers to the ability of two or more computing systems to communicate and exchange information. Syntactic interoperability is achieved using specified data formats and communication protocols. In general, eXtensible Markup Language (XML) standards and Structured Query Language (SQL) standards provide syntactic interoperability. Syntactic interoperability is necessary for semantic interoperability. The phrase “semantic interoperability” refers to the ability to automatically interpret the information exchanged meaningfully and accurately in order to produce useful results as defined by the end users of two or more computing systems.

In the healthcare industry, a plurality of healthcare computing systems have been produced for facilitating the electronic creation and management of health records and medical records by healthcare providers and organizations. These healthcare computing systems include first systems which employ Electronic Health Record (EHR) software applications and/or Electronic Medical Record (EMR) software applications which implement the same standards. The healthcare computing systems also include second systems which employ EHR software applications and/or EMR software applications which implement different standards. The first systems are interoperable, i.e., they are able to (a) exchange information therebetween and (b) use the exchanged information in a meaningful and accurate way so as to produce useful results. In contrast, the second systems are not interoperable, i.e., they may be able to exchange information, but are unable to use the exchanged information in a meaningful way.

The information exchange of the second systems is often achieved using a Portable Document Format (PDF) printer. The PDF printer is a software application that translates a document from a first format to a PDF open standard format. A document in the PDF open standard format is referred to herein as a PDF document. The PDF document may be communicated from a source computing system to a destination computer system over a network using the PDF printer. In this scenario, the PDF document is accessible by a PDF viewer running on the destination computer system. However, the structure of the PDF document is not in a format that is compatible with the EHR software application and/or the EMR software application running on the destination computing system. As such, the source and destination computer systems are not semantically interoperable.

Many conventional interface systems have been created for facilitating interoperability of computing systems employing EHR/EMR software applications which implement different standards. These interface systems are expensive to obtain. Also, each interface system typically provides an interface between a certain number of different EHR software applications and/or EMR software applications. There are hundreds of different types of EHR software applications and EMR software applications. Accordingly, a large number of interface systems are needed to facilitate the interoperability of the hundreds of diverse EHR/EMR software applications. Consequently, the multiple interface solution is impractical, costly and resource intensive.

### SUMMARY OF THE INVENTION

Embodiments of the present invention concern implementing systems and methods for providing interoperability between a plurality of computing systems employing software applications implementing a plurality of different standards. The present invention can be used in any computer-based application in which there is a print option or capability. This will become more evident as the discussion progresses.

The computing systems can include, but are not limited to, healthcare systems employing Electronic Health Record (EHR) software applications and/or Electronic Medical Record (EMR) software applications. EHR/EMR software applications are well known in the art, and therefore will not be described herein. Such healthcare systems include, but are not limited to, healthcare provider systems, web servers and health care administration systems.

The method embodiments generally involve generating, at a first computing system (e.g., a healthcare provider system), an electronic document having a first data structure. The electronic document can include, but is not limited to, a health related document (e.g., a summary of care document), a MICROSOFT® Word document, a MICROSOFT® Excel document, or a PDF document. After the electronic document is created, the user of the first computing system performs user software interactions to “print” at least a portion of the electronic document or a “current view”. As should be understood, the “current view” is not an electronic document in the traditional sense, but is able to be submitted as an electronic document. The “printing” is generally performed for communicating data contained in the electronic document or “current view” to a second computing system (e.g., a healthcare provider system, a web server or a health care administration system). Notably, the data has a data structure and associated metadata that is compatible with the second computing system. In effect, the second computing system is able to automatically interpret the data in a meaningful and accurate way. Consequently, the first and second computing systems are syntactically and semantically interoperable.

According to aspects of the present invention, the “printing” is achieved using a virtual printer that is accessible via a menu command (e.g., File>Print>Preexisting Printers from which to choose). The phrase “virtual printer”, as used herein, refers to a piece of computer software whose user interface and Application Programming Interface (API) resemble that of a printer driver, but which is not connected with a physical computer printer. The virtual printer can be configured by the user of the first computing system. As such, the virtual printer is generally operative to: receive a first user input selecting the second computing system that is to receive data contained in the electronic document or “current view”; automatically select one or more templates from a plurality of pre-defined templates based on the first user input; receive a second user input selecting one of the templates; automatically complete the template using at least a portion of the data contained in the electronic document or “current view” in response to the second user input; automatically obtain pre-defined metadata specifying at least a meaning of information contained in the template and an intended use of the information; receive user-specified metadata; and facilitate the communication of the pre-defined metadata, user-specified metadata and completed template to the second computing system. It should be understood, that in the “current view” scenario, the template may be a “fill-in-the-blank” document in which an image of the “current view” may be inserted. Since the data is in an image format, it may be desirable to the user to specify more metadata as compared to the amount of metadata specified thereby in the “electronic document” scenario.

### BRIEF DESCRIPTION OF THE DRAWINGS

Embodiments will be described with reference to the following drawing figures, in which like numerals represent like items throughout the figures, and in which:

FIG. 1 is a schematic illustration of an exemplary healthcare system that is useful for understanding the present invention.

FIG. 2 is a detailed block diagram of an exemplary healthcare provider system that is useful for understanding the present invention.

FIG. 3 is an exemplary architecture for an interoperability print driver that is useful for understanding the present invention.

FIGS. 4A-4C collectively provide a flow diagram of an exemplary method for providing interoperability between two or more diverse healthcare systems.

FIG. 5 is a schematic illustration of an application window that is useful for understanding the present invention.

FIG. 6 is a schematic illustration of an exemplary document displayed in the application window of FIG. 5 that is useful for understanding the present invention.

FIG. 7 is a schematic illustration of an exemplary menu of commands displayed in the application window of FIG. 5 that is useful for understanding the present invention.

FIGS. 8-14 provide schematic illustrations of an exemplary graphical device interface that is useful for understanding the present invention.

### DETAILED DESCRIPTION

The present invention is described with reference to the attached figures. The figures are not drawn to scale and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operation are not shown in detail to avoid obscuring the invention. The present invention is not limited by the illustrated ordering of acts or events, as some acts may occur in different orders and/or concurrently with other acts or events. Furthermore, not all illustrated acts or events are required to implement a methodology in accordance with the present invention.

The word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is if, X employs A; X employs B; or X employs both A and B, then “X employs A or B” is satisfied under any of the foregoing instances.

The present invention concerns computing systems employing software applications that implement different standards. More particularly, the present invention provides systems and methods for facilitating the interoperability between said computing systems. The interoperability is generally achieved through context awareness. The term “context”, as used herein refers to, a set of rules of inter-relationship between software applications implementing different standards. Context related to software application behavior can be structured into a plurality of categories, such as a location category and an infrastructure category (resources for computation, communication, task performance, etc . . .). The infrastructure category includes, but is not limited to, the following sub-categories: means of creation of an electronic document; time of creation of the electronic document; date of creation of the electronic document; standards implemented by the means of creation; purpose of electronic document; meaning of information contained in the electronic document; and how the information should be used.

The phrase “context awareness”, as used herein refers to, any information that can be used to characterize the situation of an entity, where an entity can be a computational object. See Dey, A. K. & Abowd, G. D., (1999), Towards a better understanding of context and context-awareness, GUV Technical Report GIT-GVU-99-22, College of Computing, Georgia Institute of Technology. Accordingly, context-awareness or context-aware computing is ‘the use of context to provide task-relevant information and/or services to a user, wherever they may be’. Id. Three (3) important context-awareness behaviors that a software application might exhibit are: (1) the presentation of information and services to a user; (2) the automatic execution of a service; and (3) the tagging of context to information for later retrieval. Id. The present invention advantageously implements these three (3) context-awareness behaviors.

In this regard, it should be understood that method embodiments of the present invention generally involve: generating information having a data structure that complies with standards employed by a software application installed on a destination computing system; deriving a context for the information that is sufficient to facilitate a meaningful use of the information at the destination computing system; communicating the information and context to the destination computing system; and using the information at the destination computing systems in a meaningful way based on the context.

The above described method is achieved using configurable interoperability software installed on a source computing system. The interoperability software can be loaded on the source computing system as a system driver. The system driver can be available to any application with a print capability. The interoperability software facilitates the display of a graphical user interface to a user of the source computing system. The graphical user interface allows the user to: select an interoperability template from a plurality of pre-defined interoperability templates; and initiate an automated process. The interoperability templates allow a user to change the data structure of information that is to be sent to the destination computing system. The automated process involves: completing the selected interoperability template using unstructured information contained in a document created by the user using a software application installed on the source computing system; generating metadata for the completed interoperability template; and communicating the metadata and completed interoperability template to the destination computing system. Notably, the metadata includes information specifying the context. In this regard, the metadata specifies a means of creation of the interoperability template, time of creation thereof, date of creation thereof, standards implemented thereby, purpose thereof, meaning of information contained therein, and how the information should be used. The interoperability template has a data structure which complies with a data structure defined by a standard implemented by a software application installed on the destination computing system.

The present invention will be described below in relation to healthcare systems. However, the present invention is not limited in this regard. For example, the present invention is applicable in any situation where there is a need for facilitating interoperability between two or more systems and software applications implementing different standards.

One such situation occurs when a determination needs to be made by a government agency. For example, a medical disability determination needs to be made in relation to a particular person. This determination is typically made by a Social Security Administration (SSA). In this regard, the SSA needs access to health information for the person. This health information is typically provided to the SSA in paper form (e.g., physical medical records and physical health records) from a plurality of sources (e.g., patients, doctors, hospitals, pharmacies, etc . . .). As a result of the paper-based process, the medical disability determination often takes months to make by the SSA. Consequently, the SSA has a backlog of medical disability matters. Such a backlog is undesirable.

The present invention provides a means for automating the SSA's medical disability determination process. More particularly, the present invention facilitates the ability to generate electronic documents having data structures compatible with software applications installed on SSA's computing system, derive contexts for the electronic documents, and submit the electronic documents to the SSA. The context includes a sufficient amount of information for facilitating a meaningful use of the information at the SSA's computing system(s). As a result of the automated process, the amount of time needed to make a medical disability determination is decreased.

### Exemplary Communication System Implementing The Present Invention

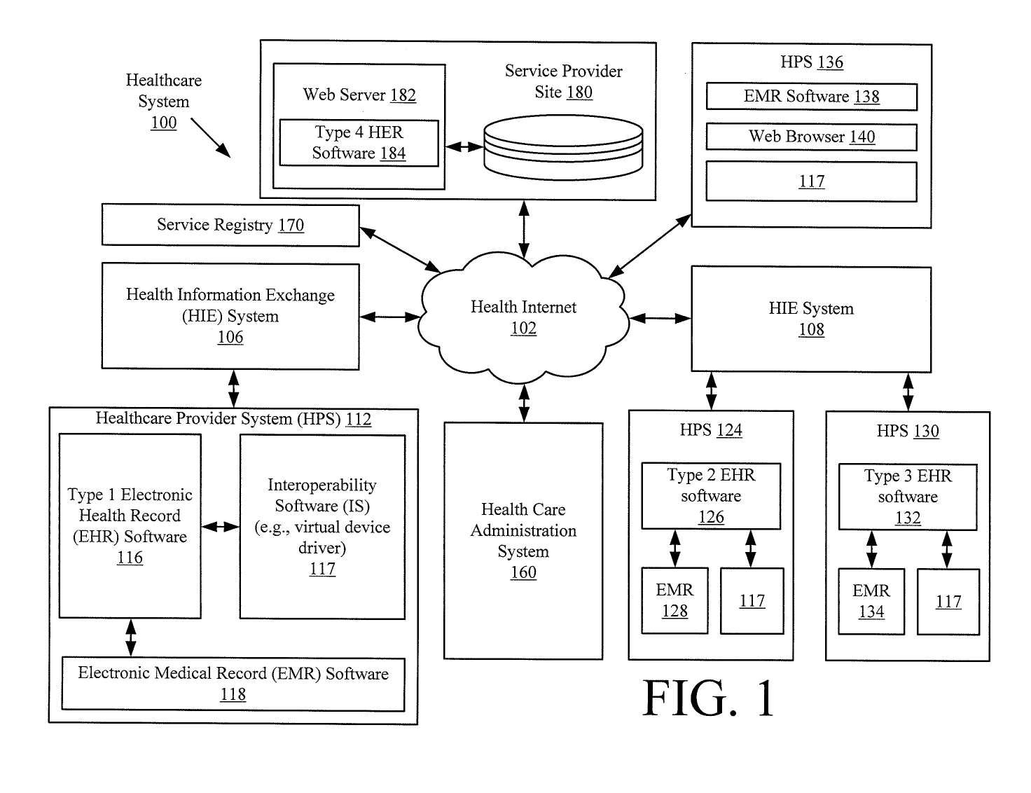

Referring now to FIG. 1, there is provided a schematic illustration of an exemplary healthcare system 100 that is useful for understanding the present invention. The healthcare system 100 provides an electronic means which facilitates public health alerting, medical disability determinations, medical benefit determinations, and medical treatment. In this regard, the healthcare system 100 provides a means for the systematic collection of electronic health information about individual patients and/or populations.

As shown in FIG. 1, the healthcare system 100 comprises Healthcare Provider Systems (HPSs) 112, 124, 130, 136, Health Information Exchange (HIE) systems 106, 108, a service provider site 180, a service registry 170, a Health Care Administration (HCA) system 160 and a health Internet 102. The health network 102 is generally a secure network that runs on top of the Internet, such as the Nationwide Health Information Network (NHIN). The phrase “secure network”, as used herein, refers to a network that employs authentication techniques and encryption techniques. Authentication and encryption techniques are well known in the art, and therefore will not be described herein. In order to facilitate the secure features of the health network 102, gateway adaptors (not shown in FIG. 1) may be provided within the network. The purpose of the gateway adaptors is to move data securely and privately across the Internet. In this regard, each of the gateway adaptors understands how to, given that the context is set properly and the right metadata is available, transform an incoming message into a form that is useful at the service provider site 180 or HIE system 106, 108. In this regard, the health internet 102 and the HIE systems 106, 108 collectively enable the exchange of information between the components 112, 124, 130, 136, 160, 170, 180 of the healthcare system 100. The health internet 102 and HIE systems 106, 108 are well known to those skilled in the art, and therefore will not be described in detail herein.

Each of the HPSs 112, 124, 130, 136 is generally configured for facilitating the recording and management of electronic health information by healthcare providers (e.g., doctors) and healthcare organizations (e.g., hospitals, medical insurance agencies, government healthcare agencies, etc. . .). In this regard, each of the HPSs 112, 124, 130, 136 has an Electronic Medical Record (EMR) software application 118, 128, 134, 138 installed thereon. EMR software applications are well known in the art, and therefore will not be described herein in detail. Still, it should be noted that any known EMR software application can be used with the present invention without limitation. Such known EMR software applications include, but are not limited to, EMR software applications which are available from: AdvancedMD Software Inc. of Delaware; Allscripts, LLC of Chicago, Ill.; Aprima Medical Software, Inc. of Carrollton, Tex.; and/or Integritas, Inc. of Monterey, Calif.

The EMR software applications 118, 128, 134, 138 generally facilitate the creation of computerized medical records by healthcare providers (e.g., doctors, nurses and administrators of healthcare facilities). The EMR software applications 118, 128, 134, 138 also allow for the storage, retrieval and manipulation of the computerized medical records. The EMR software applications 118, 128, 134, 138 are further operative to monitor clinical events, by analyzing patient data from an electronic health record to predict, detect and potentially prevent adverse events. The electronic health records will be described below.

Each of the HPSs 112, 124, 130 also has an Electronic Health Record (EHR) software application installed thereon. EHR software applications are well known in the art, and therefore will not be described herein in detail. Still, it should be noted that any known EHR software application can be used with the present invention without limitation. Such known EHR software applications include, but are not limited to, EHR software applications which are available from: AdvancedMD Software Inc. of Delaware; Allscripts, LLC of Chicago, Ill.; Aprima Medical Software, Inc. of Carrollton, Tex.; and Integritas, Inc. of Monterey, Calif.

The EHR software applications facilitate the creation of electronic heath records and the sharing of the electronic heath records across the health internet 102. The electronic health records can include, but are not limited to, discharge orders, transfer orders, pharmacy orders, radiology results, laboratory results, provider notes and any other records from ancillary services. Accordingly, the data contained in the electronic health records includes demographics, medical history, medication and allergies, immunization status, laboratory test results, radiology images and/or billing information.

As shown in FIG. 1, the HPS 136 does not have an EHR software application installed thereon. Still, the HPS 136 obtains access to an EHR software application 184 installed on a web server 182 of a service provider site 180 via a web browser 140 and a web portal.

Notably, there are numerous types of EHR/EMR software applications. The HPSs 112, 124, 130, 136 and web server 182 may employ the same or different types of EHR/EMR software applications. For example, the HPS 112 employs EHR/EMR software 116, 118 of a first type (e.g., EHR/EMR software implementing an HL7 standard). The HPS 124 employs EHR/EMR software 126, 128 of a second type (e.g., EHR/EMR software implementing a standard other than an HL7 standard). The HPS 130 employs EHR/EMR software 132, 134 of a third type (e.g., EHR/EMR software which implements a first proprietary standard that does not comply with any other non-proprietary healthcare standard). The HPS 136 and web server 182 collectively employ EHR/EMR software 184, 138 of a fourth type (e.g., EHR/EMR software which implements a second proprietary standard that does not comply with any other proprietary healthcare standard). In this scenario, the different types of EHR/EMR software are not interoperable, i.e., they can not automatically interpret information generated and output from one another in a meaningful manner so as to produce useful results as defined by users thereof.

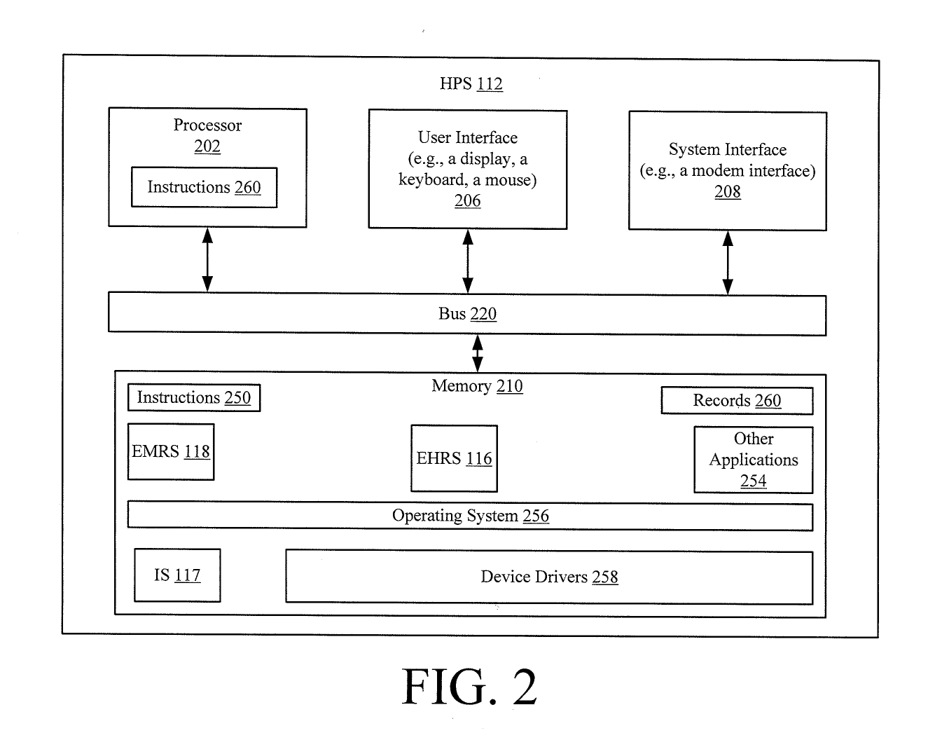

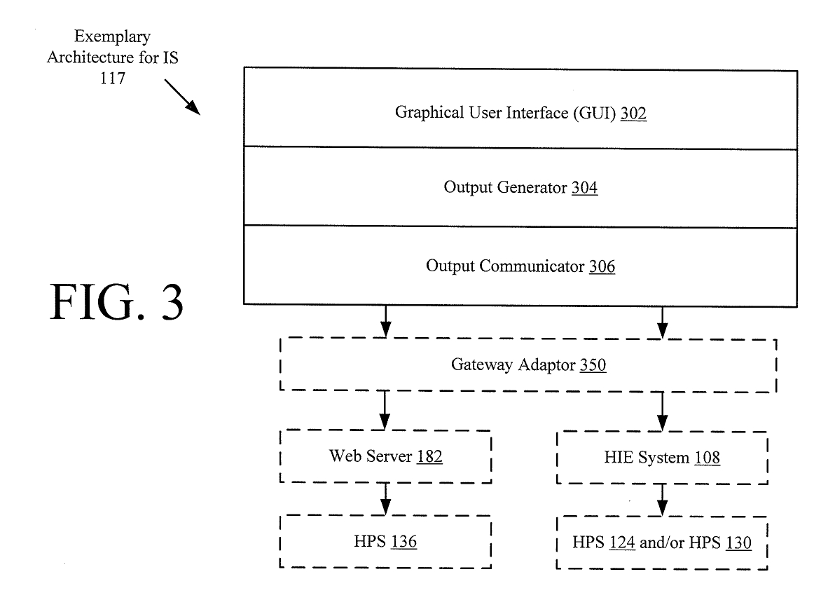

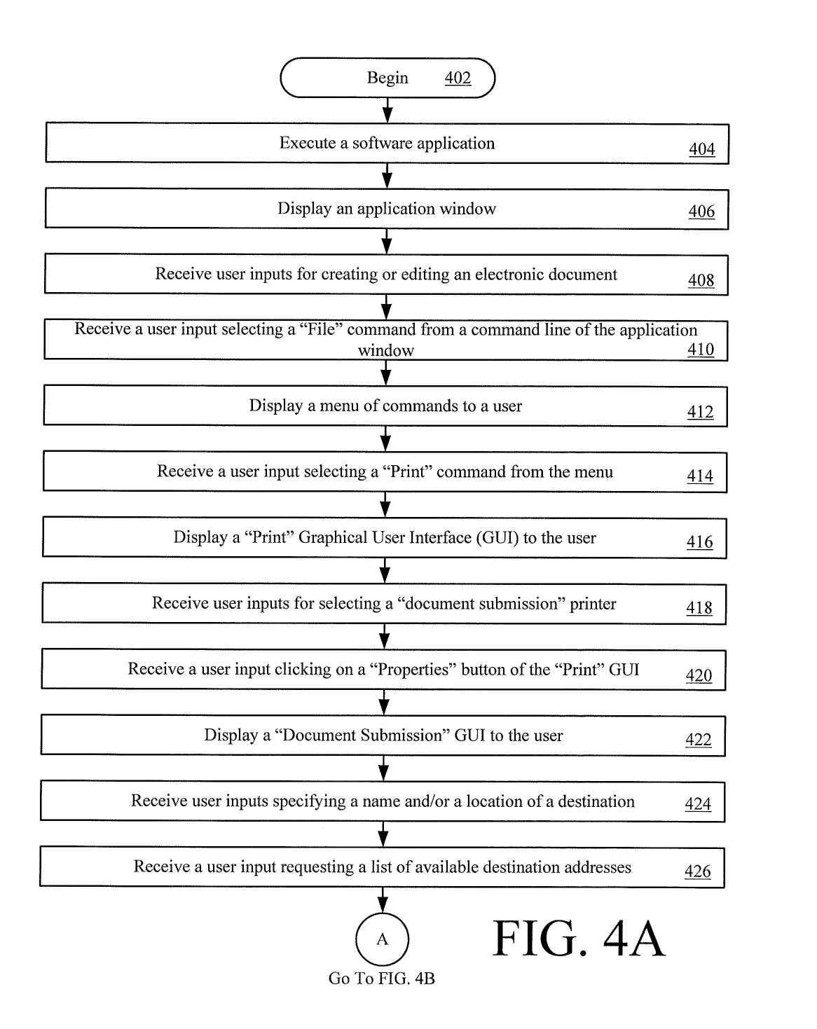

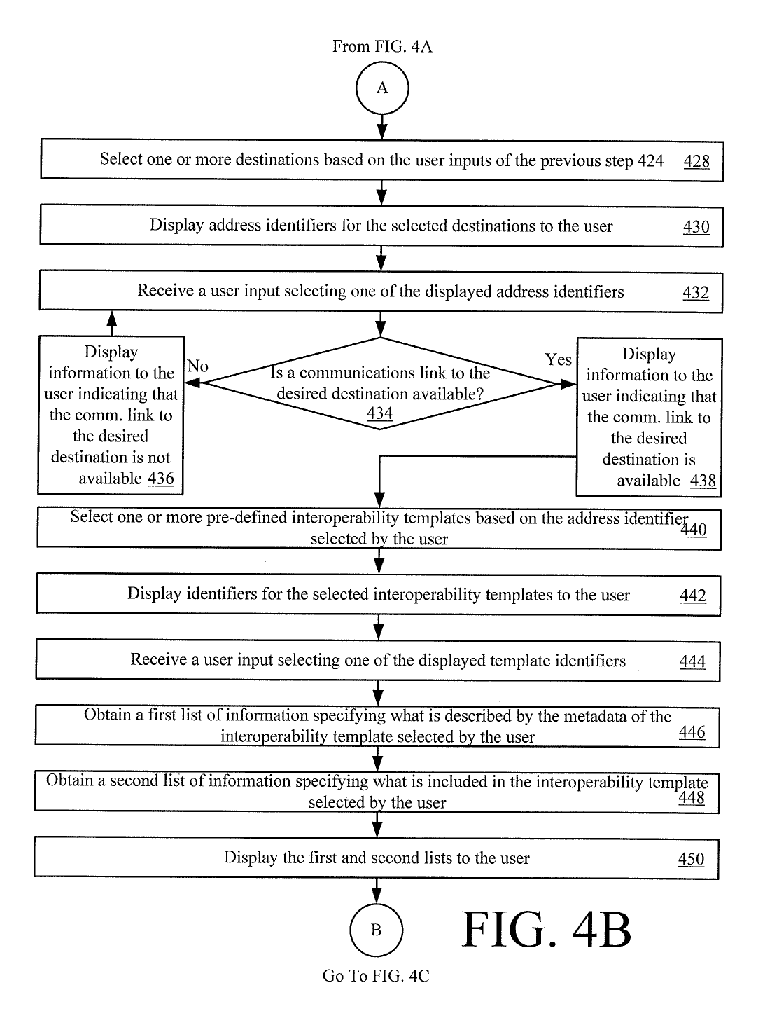

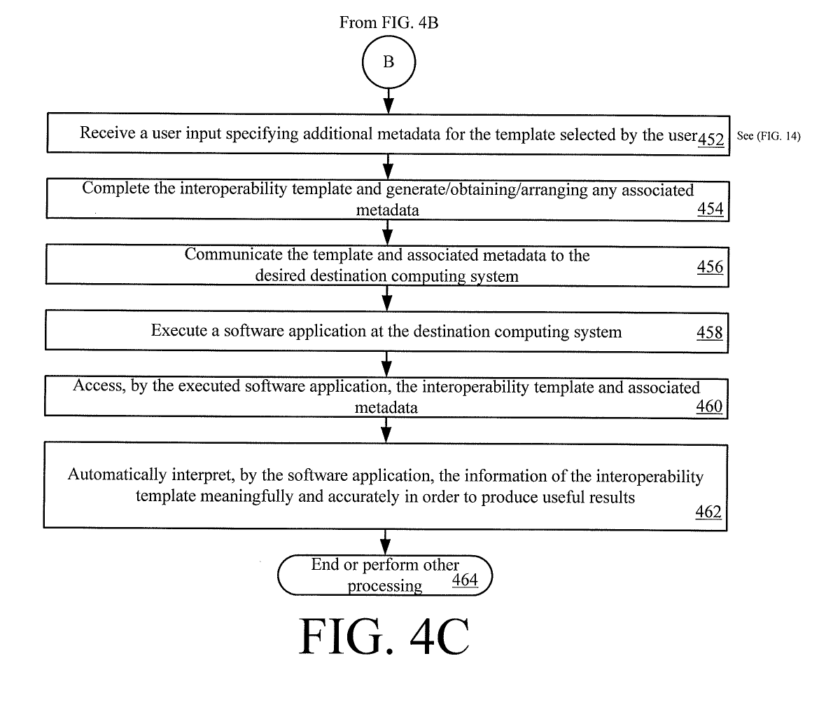

In order to facilitate the interoperability of EHR/EMR software applications that implement different standards, each of the HPSs 112, 124, 130, 136 is provided with Interoperability Software (IS) 117. The IS 117 implements method embodiments of the present invention. The method embodiments will be described in detail below in relation to FIGS. 4A-14. Still, it should be understood that the IS 117 can be a virtual device (e.g., a virtual printer) that generally provides a means for converting information contained in a document from a first data structure format to a second data structure format that is compatible with the EHR/EMR software applications installed on another computing system 112, 124, 130, 136, 182. The IS 117 (in conjunction with HIE systems 106, 108 and health internet 102) also provides a means for exchanging the information in the second data structure format between a source computing system (e.g., HPS 112, 124, or 130) and a destination computing system (e.g., HPS 136 or HCA system 160). The IS 117 will be described in more detail below in relation to FIGS. 2-3.

Referring now to FIG. 2, there is provided a detailed block diagram of the HPS 112 that is useful for understanding the present invention. Notably, the HPSs 124, 130, 136 are the same as or similar to the HPS 112. As such, the discussion provided below in relation to the HPS 112 is sufficient for understanding the HPSs 124, 130, 136.

The HPS 112 may include more or less components than those shown in FIG. 2. However, the components shown are sufficient to disclose an illustrative embodiment of an HPS 112 implementing the present invention. The hardware architecture of FIG. 2 represents one embodiment of a representative HPS 112 configured to facilitate the interoperability of diverse EHR/EMR software applications. As such, the HPS 112 of FIG. 2 implements method embodiments of the present invention. Exemplary method embodiments of the present invention will be described below in relation to FIGS. 4A-14.

As shown in FIG. 2, the HPS 112 can include a computer workstation, desktop personal computer system, a laptop personal computer system, or any other general purpose computer processing device. As such, the HPS 112 is comprised of a system interface 208, a user interface 206, a processor 202, a system bus 220, and a memory 210 connected to and accessible by other portions of the HPS 112 through system bus 220. The HPS 112 is coupled to an external device (e.g., the HIE 106 of FIG. 1) through the system interface 208. The system interface 208 allows the HPS 112 to communicate directly with the external devices (e.g., the HIE 106 of FIG. 1) via a wired or wireless communications link. As such, the system interface 208 sends data (for example, one or more healthcare related documents) to external devices (e.g., HPSs 124, 130, 136 of FIG. 1). The system interface 208 also receives data (for example, healthcare related documents) sent from external devices (e.g., HPSs 124, 130, 136 of FIG. 1).

The processor 202 perform actions involving access to and use of memory 210, which may be a Random Access Memory (RAM) and/or a Read Only Memory (ROM). The processor 202 may include, but is not limited to, microprocessors, ASICs and other hardware. The processor 202 is programmed for facilitating the interoperability of different EHR/EMR software applications. In this regard, it should be understood that the processor 202 can access data files 260 stored in memory 210. The data files 260 include, but are not limited to, electronic health records, electronic medical records, document templates and interoperability templates. The templates will be described below. The processor 202 can also access and run device drivers 258, an operating system 256 and various software applications installed on the HPS 112. The software applications can include, but are not limited to, the EMR software application 118, the EHR software application 116, a web browser application (not shown), graphical user interface software programs (not shown), the IS 117 and/or other software applications 254.

The EHR/EMR software applications 116, 118 are operative to enable: the opening of an application window; the selection of a document template with a menu command (e.g., File>New>Preexisting Document Templates from which to choose); the completion of the selected document template; the storage of the completed document template; and the editing of the stored document template. The document templates can include, but are not limited to, consultation templates, summary of care (C32) document templates, emergency of care (C28) document templates, prescription templates, hospital discharge template, a referral template, a referral results template, a population health alert template and bill templates. Each of the document templates is a “fill-in-the-blank” document that is completed through an user-software interactive process. The user-software interactive process involves receiving user inputs for inputting data into entries of the document templates. The EHR/EMR software applications 116, 118 are also operative to enable the printing of document templates. In this regard, the EHR/EMR software applications 116, 118 include a menu that enables the selection of a physical computer printer and/or a virtual printer with a menu command (e.g., File>Print>Preexisting Printers from which to choose). The phrase “virtual printer”, as used herein, refers to a piece of computer software whose user interface and Application Programming Interface (API) resemble that of a printer driver, but which is not connected with a physical computer printer. Printer drivers are well known in the art, and therefore will not be described herein.

The IS 117 is operative to facilitate the interoperability of two or more different types of EHS/EMS software applications (i.e., software applications that implement different standards). In this regard, the IS 117 is operative to enable: the selection of a “document submission” printer with a menu command that is accessible via an application window (e.g., File>Print>Document Submission); and the customization of operations of the “document submission” printer via a Graphical User Interface (GUI). The GUI is accessible via a command (e.g., File>Print>Document Submission>Properties). The properties include, but are not limited to, destination properties, template properties, metadata properties and link properties. The destination properties include, but are not limited to, destination name, destination location and destination address. The template properties include, but are not limited to, interoperability templates and information contained in the interoperability templates. The metadata properties include, but are not limited to, pre-defined metadata for interoperability templates and user-defined metadata for interoperability templates. The link properties include, but are not limited to, link availability and link quality.

The interoperability templates include pre-defined templates that are compatible with a plurality of different EHR/EMR software applications. In this regard, data is structured within the interoperability templates in accordance with the data abstraction model employed by a destination computing system. Data abstraction models are well known in the art, and therefore will not be described herein. However, it should be understood that data abstraction models generally define data structures and rules for allowing the handling of data bits in a meaningful way.

According to embodiments of the present invention, each of the interoperability templates is a “fill-in-the-blank” document that is completed through an automated process. The automated process generally involves automatically retrieving information from a document (e.g., a summary of care document) that was completed or edited by a user of the HPS 112, and automatically inserting the information in the proper entries of a user-selected interoperability template. The automated process also involves automatically generating metadata for the completed interoperability template. In some embodiments, the metadata includes only pre-defined metadata. In other embodiments, the metadata includes pre-defined metadata and user-defined metadata. In either scenario, the metadata includes a sufficient amount of information for facilitating the meaningful use of information contained in an exchanged interoperability template at a destination computing system (e.g., the HPSs 124, 130, 136, the HCA system 160 and/or the web server 182 of FIG. 1). Embodiments of the present invention are not limited in this regard.

In general, the pre-defined metadata includes, but is not limited to, information specifying the means of creation of a completed interoperability template; time of creation of the completed interoperability template; date of creation of the completed interoperability template; standards implemented by the means of creation; purpose of the completed interoperability template; meaning of information contained in the completed interoperability template; and how the information should be used. The user-defined metadata includes, but is not limited to, additional information that a user of the HPSs 112 wants to provide to an intended recipient. The additional information can include, but is not limited to, information that is not contained in the corresponding interoperability template. Such additional information includes, but is not limited to, demographics, billing information, information relating to physical and biological characteristics of a patient (e.g., a drug allergy, a medical condition, a blood type, an age), information relating to a relative, and information relating to a fetus (e.g., blood type).

After the completion of the interoperability template and the generation of the metadata, the IS 117 performs actions for communicating the same to one or more external devices (e.g., the HPSs 124, 130, 136, the HCA system 160 and/or the web server 182 of FIG. 1). These actions can include, but are not limited to, interacting with the system interface 208 for communicating a completed interoperability template or a copy thereof to one or more external devices (e.g., the HPSs 124, 130, 136, the HCA system 160 and/or the web server 182 of FIG. 1). The interaction between the IS 117 and the system interface 208 is facilitated by the operating system 256 and other device drivers 258. The interoperability template and metadata can be communicated from the HPS 112 in response to a user input and/or in response to the reception of a request therefore from an external device (e.g., the HPSs 124, 130, 136, the HCA system 160 and/or the web server 182 of FIG. 1).

An exemplary architecture of the IS 117 is provided in FIG. 3. As shown in FIG. 3, the IS 117 comprises a GUI 302, an output generator 304 and an output communicator 306. The GUI 302 allows a user of the HPS 112 to interact with IS 117 for selecting a “document submission” printer and customizing operations of the “document submission” printer. As noted above, the operations of the “document submission” printer are customized by: selecting a destination computing system; selecting one of a plurality of pre-defined interoperability templates; specifying additional metadata; and initiating an automated process. The automated process is performed for completing the selected interoperability template, generating metadata and communicating the same to an external device. The output generator 304 generates an output of the IS 117. The output is generated by automatically completing the selected interoperability template and automatically generating metadata. The output communicator 306 communicates interoperability templates and associated metadata to external devices (e.g., a gateway adaptor 350 of FIG. 3, the HPSs 124, 130, 136, the HCA system 160 and/or the web server 182 of FIG. 1). The communication can be made in response to a user input or a reception of a request from an external device.

Referring again to FIG. 2, instructions 250 (e.g., software code) are stored in memory 210. The instructions 250 are configured to implement one or more of the methodologies, procedures, or functions described herein. The instructions 250 can also reside, completely or at least partially, within the processor 202 during execution thereof by the HPS 112. The memory 210 and the processor 202 constitute machine-readable media. The term “machine-readable media”, as used here, refers to a single medium or multiple media that store the one or more sets of instructions 250. The term “machine-readable media”, as used here, also refers to any medium that is capable of storing, encoding or carrying a set of instructions 250 for execution by the HPS 112 and that cause the HPS 112 to perform any one or more of the methodologies of the present disclosure.

As evident from the above discussion, the healthcare system 100 implements one or more method embodiments of the present invention. The method embodiments of the present invention can be used in systems employing a plurality of diverse software applications. Exemplary method embodiments of the present invention will now be described in relation to FIGS. 4A-14.

### EXEMPLARY METHOD EMBODIMENTS OF THE PRESENT INVENTION

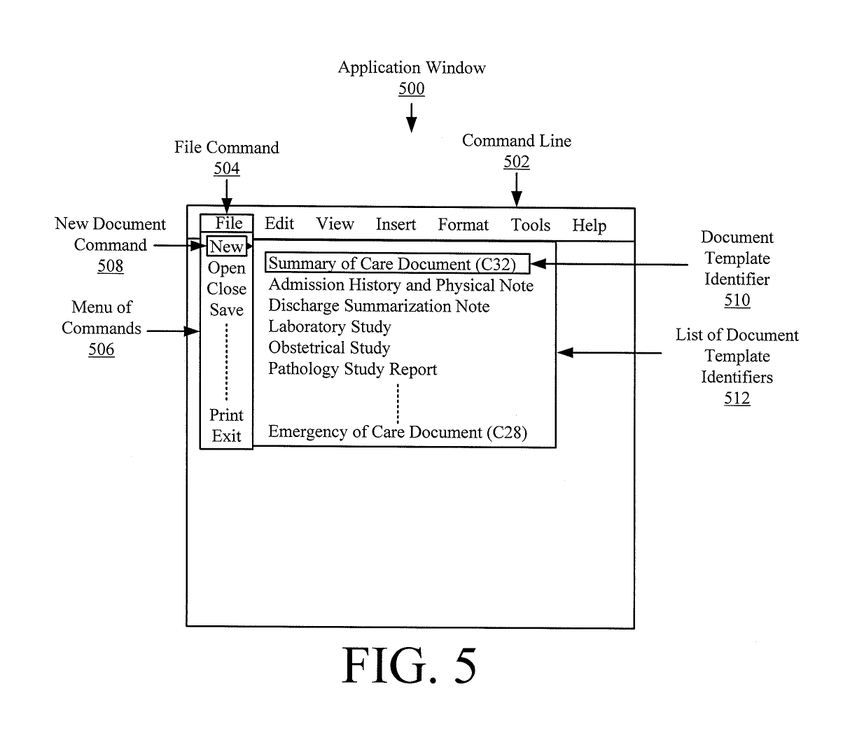

Referring now to FIGS. 4A-4C, there is provided a flow diagram of an exemplary method 400 for providing interoperability between two or more computing systems employing software applications implementing different standards. As shown in FIG. 4A, the method begins with step 402 and continues with step 404. In step 404, a software application is executed. The software application is installed on a source computing system (e.g., HPS 112 of FIG. 1). The software application can include, but is not limited to, an EHR software application (e.g., an application 116, 126, 132, 184 of FIG. 1), an EMR software application (e.g., an application 118, 128, 134, 138 of FIG. 1), a web browser (e.g., web browser 140 of FIG. 1), a word processor (e.g., MICROSOFT® Word), a PDF viewer, and a spreadsheet application (e.g., MICROSOFT® Excel). After step 404, an application window is displayed to a user of the source computing system, as shown by step 406. A schematic illustration of an exemplary application window 500 is provided in FIG. 5.

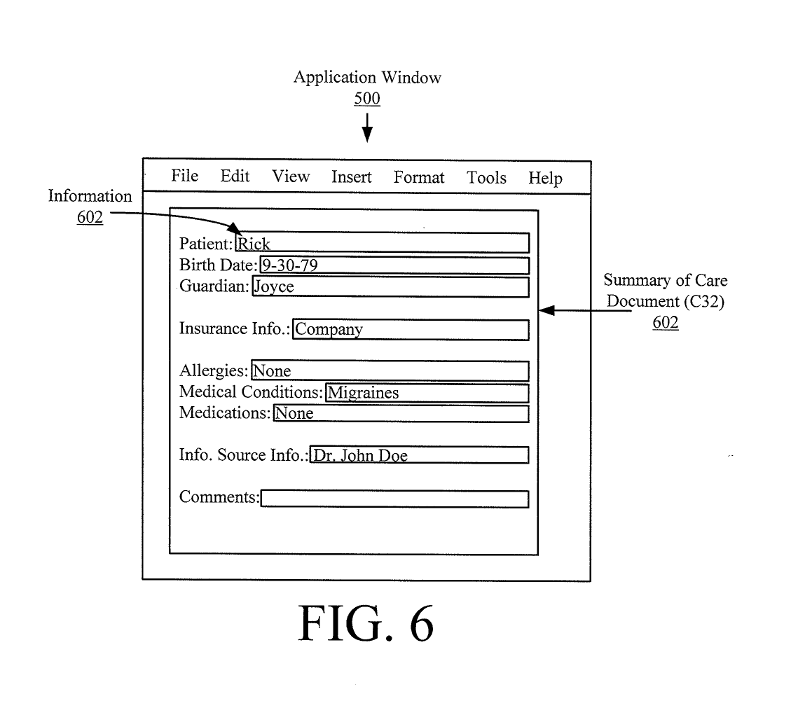

In a next step 408, the source computing system receives user inputs for creating or editing an electronic document. Processes for creating and editing electronic documents are well known in the art. However, an exemplary process for creating a document will be described in relation to FIGS. 5 and 6. As shown in FIGS. 5-6, a document can be created by: selecting a “File” command of a command line 502 of the application window 500; selecting a “New Document” command 508 from a menu of commands 506; and selecting an identifier 510 for a pre-defined document template (e.g., a summary of care document template 602) from a list of document identifiers 512. In response to the selection of the identifier 510, the corresponding pre-defined document template is displayed to the user via the application window 500. Subsequently, the user performs user-software interactions for inputting information 602 in the document template.

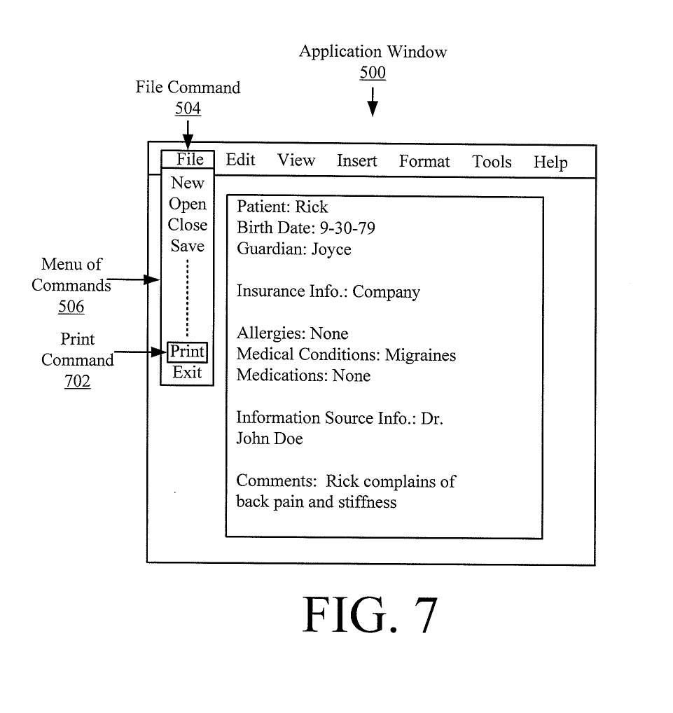

Referring again to FIG. 4A, the method 400 continues with step 410. In step 410, the source computing system receives a user input selecting a “File” command 504 from the command 502 of the application window 500. In response to the user input, step 412 is performed where the menu of commands 506 is displayed to the user. Thereafter, the source computing system receives a user input selecting a “Print” command (e.g., “Print” command 702 shown in FIG. 7) from the menu of commands 506, as shown by step 414. The process of steps 410-414 is illustrated schematically in FIG. 7.

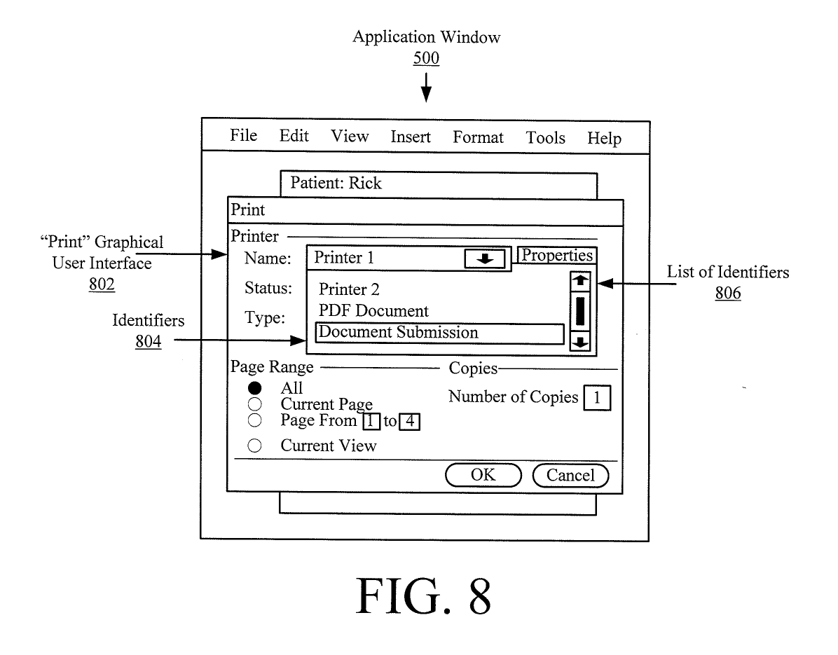

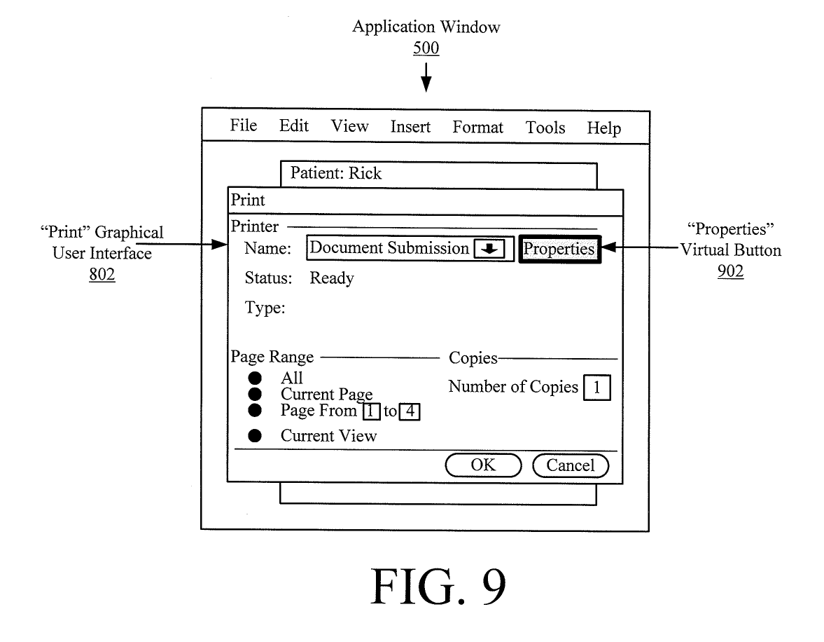

After step 414, the method continues with steps 416-420. Steps 416-420 will be described in relation to FIGS. 8-9. Step 416 involves displaying a “Print” GUI 802 to the user of the source computing system. The “Print” GUI 802 includes a means for allowing a user to select a printer from a plurality of printers. The printers can include, but are not limited to, physical computer printers and virtual printers (e.g., a virtual PDF printer and the IS 117 of FIG. 1). The phrase “virtual printer”, as used herein, refers to a piece of computer software whose user interface and API resemble that of a printer driver, but which is not connected with a physical computer printer. Accordingly, each of the printers can be implemented in hardware, software and/or a combination thereof. The “Print” GUI 802 also includes a means for accessing another GUI for customizing properties of a selected printer. The “Print” GUI 802 may further include a means for allowing a user to specify a page range and a number of copies. Notably, the “Print” GUI 802 is displayed in response to the user selection of the “Print” command 702.

In a next step 418, the source computing system receives a user input selecting an identifier 804 for a “Document Submission” printer from a list of printers 806 of the “Print” GUI 802. After selecting identifier 804, the user clicks on a properties virtual button 902 for accessing a GUI which allows the user to customize properties of the “Document Submission” printer. As should be understood, the clicking on a virtual button is typically achieved using an electronic device (e.g., a mouse of a computer).

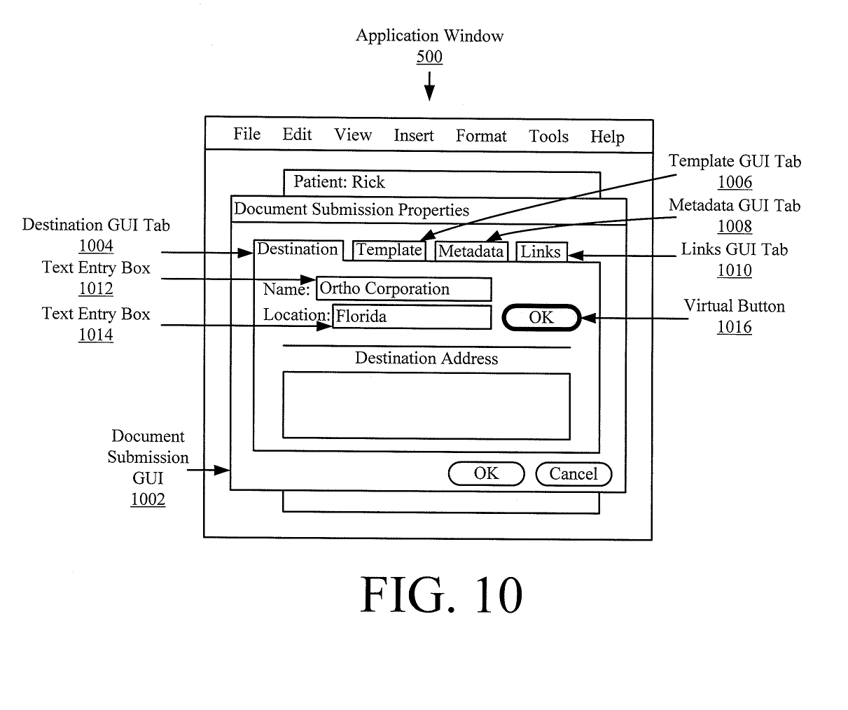

In response to the selection of the “properties” virtual button 902, a “Document Submission” GUI is displayed to the user. A schematic illustration of an exemplary “Document Submission” GUI 1002 is provided in FIG. 10. As shown in FIG. 10, the “Document Submission” GUI 1002 includes, but is not limited to, a “Destination” GUI tab 1004, a “Template” GUI tab 1006, a “Metadata” GUI tab 1008 and a “Links” GUI tab 1010.

After the “Document Submission” GUI is displayed to the user, the source computing system receives user inputs specifying a name and/or a location of a desired recipient, as shown by step 424. These user inputs can be achieved by inputting text information in text entry boxes (e.g., text entry boxes 1012, 1014 of FIG. 10) of the “Document Submission” GUI. Once the user has inputted the requisite text information, he or she clicks on a virtual button (e.g., virtual button 1016 of FIG. 10). By clicking the virtual button, the user has requested that a list of available destination addresses be presented to him or her by the source computing system.

In response to the user-software interaction of step 426, the method continues with step 428 of FIG. 4B. As shown in FIG. 4B, step 428 involves selecting one or more destinations based on the user inputs of previous step 424. The destinations are selected by: communicating a request for destination information from the source computing system to a service registry (e.g., the service registry 170 of FIG. 1); performing operations at the service registry for selecting one or more destinations based the information contained in the request; retrieving address identifiers for the selected destinations; communicating the address identifiers from the service registry to the source computing system; and receiving the address identifiers at the source computing system.

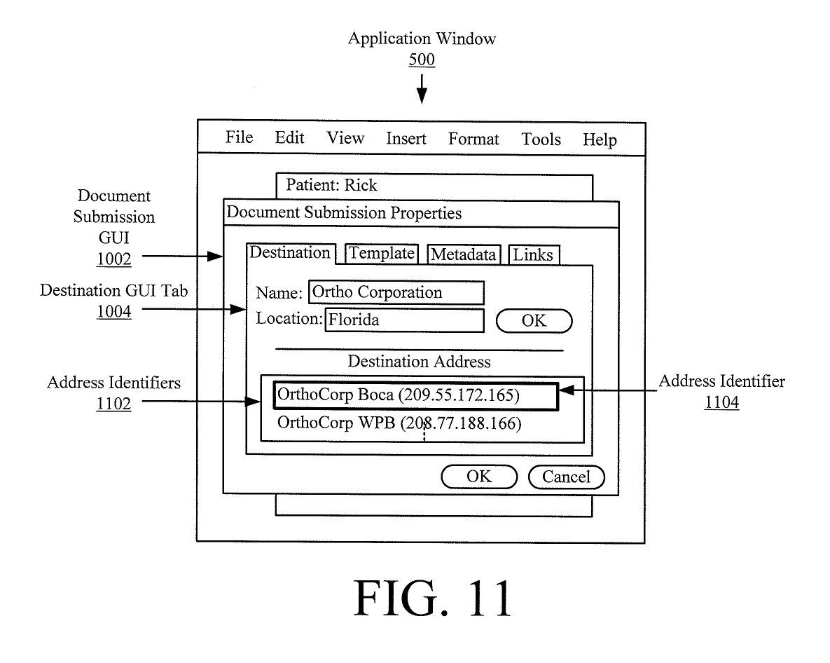

Upon completing step 428, the method 400 continues with step 430. In step 430, the address identifiers are displayed to the user. A schematic illustration of exemplary address identifiers 1102 being displayed in the “Destination” GUI tab 1004 of the “Document Submission” GUI 1002 is provided in FIG. 11. As shown in FIG. 11, the address identifiers 1102 include address identifiers for specific computer systems associated with Florida based organizations having names that are the same as or similar to that of an intended recipient (e.g., Ortho Corporation). Embodiments of the present invention are not limited in this regard. For example, the address identifiers 1102 can alternatively or additionally include identifiers for email addresses and server addresses.

Referring again to FIG. 4B, a next step 432 involves receiving, at the source computing system, user inputs selecting one of the displayed address identifiers. The address identifier can be selected by moving a cursor of a mouse over the address identifier and depressing a button on the mouse. As shown in FIG. 11, an address identifier 1104 for a computing system of an organization named Ortho Corporation and located in Boca, Fla. is selected in the above described manner.

After a user has selected an address identifier, a decision is made in step 434 as to whether a communications link between the source computing system (e.g., HPS 112 of FIG. 1) and a desired destination computing system (e.g., HPS 124 of FIG. 1) is available. Methods for determining whether a communications link is available are well know in the art, and therefore will not be described herein. However, it should be understood that any of these known methods can be used with the present invention without limitation.

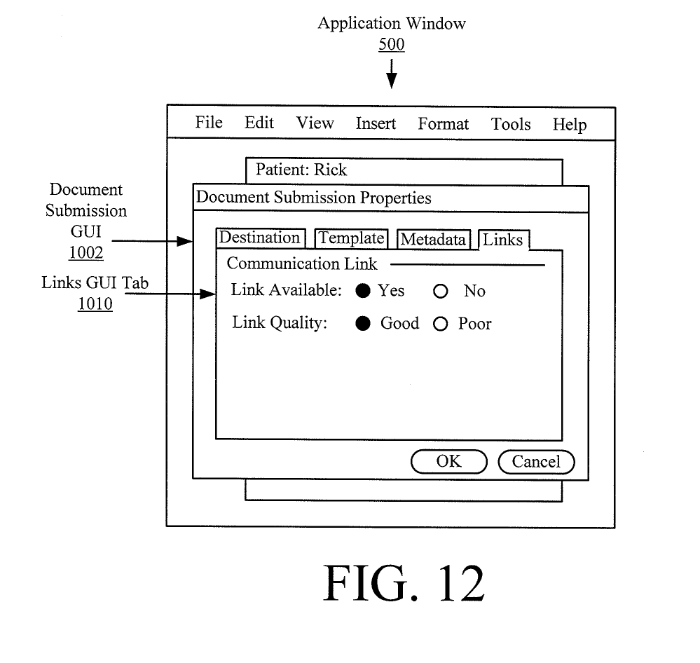

If a communications link is not available [434:N0], then step 436 is performed where information is displayed to the user indicating that the communication link to the desired destination is not available. This information can be displayed to the user via the “Links” GUI tab 1010 of the “Document Submission” GUI 1002. A schematic illustration of an exemplary “Links” GUI tab 1010 is provided in FIG. 12. As shown in FIG. 12, the “Links” GUI tab 1010 displays information indicating whether or not a communication link to the desired destination computing system is available. The “Links” GUI tab 1010 can also optionally display information indicating whether the quality of the communication link is good or poor. The “Links” GUI tab 1010 can further display other information than that shown in FIG. 12, provided that the information is related to the characteristics of a communications link to a desired destination computing system (e.g., HPS 124 of FIG. 1). Upon completing step 436, the method 400 returns to step 432.

If a communications link is available [434:YES], then step 438 is performed where information is displayed to the user indicating that the communication link to the desired destination is available. This information can be displayed to the user via the “Links” GUI tab 1010 of the “Document Submission” GUI 1002 as shown in FIG. 12. Thereafter, step 440 is performed.

In step 440, the source computing system selects one or more interoperability templates from a plurality of pre-defined interoperability templates based on the address identifier selected by the user in previous step 432. The selection can be achieved by: requesting information from the service registry about the destination computing system associated with the address identifier selected by the user; receiving said information from the service registry; and using the information to select interoperability templates that are compatible with one or more software applications installed on the destination computing system. The information can include information indicating the type of software applications that are installed on the destination computing system. For example, the information indicates that the destination computing system (e.g., HPS 124 of FIG. 1) employs an EHR/EMR software application of a particular type. Embodiments of the present invention are not limited in this regard.

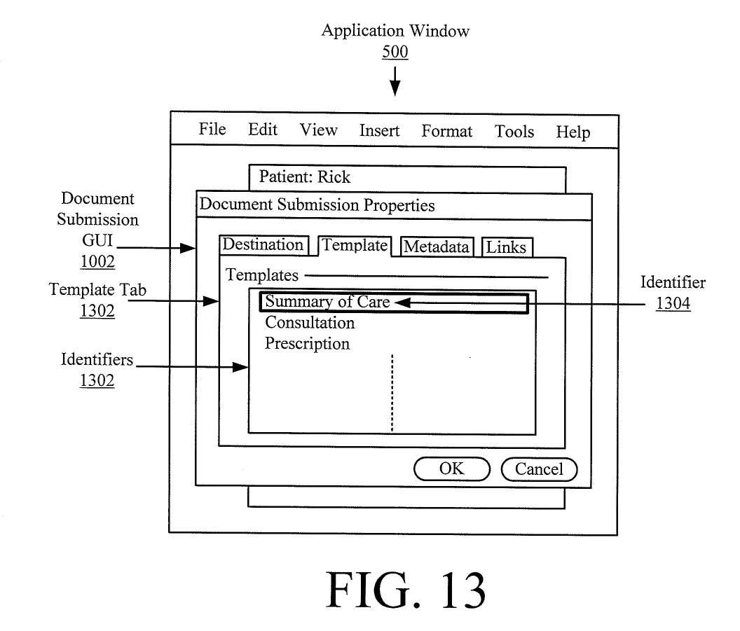

After selecting one or more pre-defined interoperability templates, identifiers for the selected interoperability templates are displayed to the user of the source computing system, as shown by step 442. The identifiers can be displayed to the user via the “Template” GUI tab of the “Document Submission” GUI. A schematic illustration of exemplary identifiers 1302 displayed in the Template” GUI tab 1006 of the “Document Submission” GUI 1002 is provided in FIG. 13.

In a next step 444, the source computing system receives a user input selecting an identifier from the displayed identifiers. The identifier can be selected by moving a cursor of a mouse over the identifier and depressing a button on the mouse. As shown in FIG. 13, an identifier 1304 for a summary of care template is selected in the above described manner.

In response to the user-software interaction of step 444, the method 400 continues with steps 446 and 448. In step 446, a first list of information is obtained by the source computing system. The first list of information can be obtained from a memory (e.g., memory 210 of FIG. 2) of the source computing system. In this regard, it should be understood that the first list can be pre-determined and pre-stored in the memory of the source computing system. The information of the first list generally indicates what is described by the pre-defined metadata of the interoperability template selected by the user. For example, the information indicates that the pre-defined metadata defines a means of creation, a purpose, a time of creation, a date of creation and the standards used for generating an interoperability template (e.g., summary of care template that is compatible with an EHS/EMR software application of a particular type). Embodiments of the present invention are not limited in this regard.

In step 448, a second list of information is obtained by the source computing system. The second list of information can be obtained from a memory (e.g., memory 210 of FIG. 2) of the source computing system (e.g., HPS 112 of FIGS. 1-2). In this regard, it should be understood that the second list can be pre-determined and pre-stored in the memory of the source computing system. The information of the second list indicates what is included in the interoperability template selected by the user. For example, the information of the second list indicates that data specifying the patient's name, age, medical condition, blood type and doctor comments will be included in the interoperability template. Embodiments of the present invention are not limited in this regard.

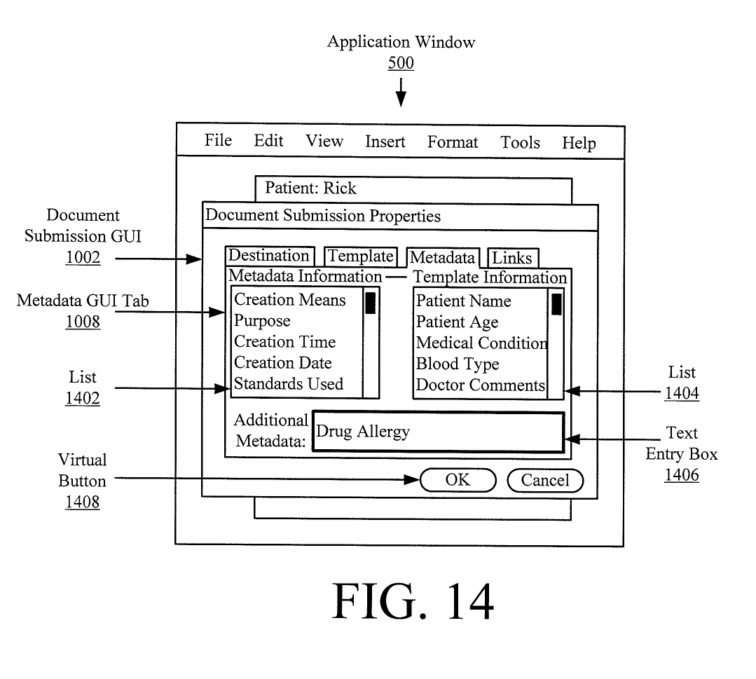

Upon completing step 448, step 450 is performed. In step 450, the first and second lists are displayed to the user. The lists can be displayed to the user via the “Metadata” GUI tab of the “Document Submission” GUI. A schematic illustration of exemplary first and second lists 1402, 1404 displayed in the “Metadata” GUI tab 1008 of the “Document Submission” GUI 1002 is provided in FIG. 14.

Referring again to FIG. 4B, the method 400 continues with step 452 of FIG. 4C subsequent to the completion of step 450. As shown in FIG. 4C, step 452 involves receiving, at the source computing system, a user input specifying additional metadata for the interoperability template selected by the user. These user inputs can be achieved by inputting text information in a text entry box (e.g., text entry box 1406 of FIG. 14) of the “Document Submission” GUI. Once the user has inputted the requisite text information, he or she clicks on a virtual button (e.g., virtual button 1408 of FIG. 14). By clicking the virtual button, the user has initiated an automated process. The automated process is performed for completing the interoperability template selected by the user, generating metadata for the interoperability template and communicating the same to an external device. This automated process will be described below in relation to steps 454-456 of FIG. 4C.

As shown in FIG. 4C, the interoperability document is completed in step 454. The interoperability template is completed by: automatically retrieving information from the document created by the user in previous step 408; and automatically inserting the information in the proper entries of the interoperability template. Step 454 also involves generating, obtaining and/or arranging the associated metadata. Methods for generating/obtaining/arranging metadata are well known in the art, and therefore will not be described herein. However, it should be understood that any of the known methods can be used with the present invention without limitation. Notably, the metadata includes pre-defined metadata and the additional metadata specified by the user in previous step 452. In this regard, the metadata includes a sufficient amount of information for facilitating the meaningful use of information contained in the interoperability template at the destination computing system (e.g., the HPS 124 of FIG. 1).

In a next step 456, the completed interoperability template and associated metadata are communicated to the destination computing system (e.g., HPS 124 of FIG. 1). In some embodiments, the interoperability template and associated metadata are held at an HIE system (e.g., HIE system 108 of FIG. 1) until a user of the destination computing system indicates that he or she wants to access, view and/or use the information contained in the interoperability template. Embodiments of the present invention are not limited in this regard.

At the destination computing system, steps 458-462 are performed. Step 458 involves executing a software application at the destination computing system. The software application can include, but is not limited to, an EHR software application (e.g., an application 116, 126, 132, 184 of FIG. 1), an EMR software application (e.g., an application 118, 128, 134, 138 of FIG. 1), a web browser (e.g., web browser 140 of FIG. 1) or a word processor (e.g., MICROSOFT® Word). In step 460, the interoperability template and metadata is accessed by the software application that was executed in previous step 458. In some embodiments of the present invention, a notification is presented to the user via an application window. The notification can include, but is not limited to, an icon and a hyperlink. The notification indicates that an interoperability template has been sent from a source computing system to the destination computing system. By selecting the notification, the interoperability template is automatically retrieved from the HIE system (e.g., HIE 108 of FIG. 1) and/or displayed to the user of the destination computing system (e.g., HPS 124 of FIG. 1). The notification can be selected by moving a curser of a mouse thereover and depressing a button on the mouse. Embodiments of the present invention are not limited in this regard.

Subsequent to step 460, step 462 is performed where the software application automatically interprets the information of the interoperability template. The information is interpreted meaningfully and accurately in order to produce useful results. Thereafter, step 464 is performed where the method 400 ends or other processing is performed.

All of the apparatus, methods and algorithms disclosed and claimed herein can be made and executed without undue experimentation in light of the present disclosure. While the invention has been described in terms of preferred embodiments, it will be apparent to those of skill in the art that variations may be applied to the apparatus, methods and sequence of steps of the method without departing from the concept, spirit and scope of the invention. More specifically, it will be apparent that certain components may be added to, combined with, or substituted for the components described herein while the same or similar results would be achieved. All such similar substitutes and modifications apparent to those skilled in the art are deemed to be within the spirit, scope and concept of the invention as defined.

We claim:

1. A method for providing interoperability between a plurality of computing systems employing software applications implementing a plurality of different standards, comprising:
generating, at a first computing system of said plurality of computing systems, an electronic document having a first data structure;
receiving, at said first computing system, a first user input selecting a second computing system that is to receive data contained in said electronic document;
automatically selecting, by said first computing system, at least one template from a plurality of pre-defined templates based on said first user input, said template having a second data structure that is different than said first data structure and with which said second computing system is compatible;
automatically completing, by said first computing system, said template using at least a portion of said data contained in said electronic document;
automatically obtaining, by said first computing system, pre-defined metadata specifying at least a meaning of information contained in said template and an intended use of said information; and
communicating said pre-defined metadata and said template from said first computing system to said second computing system.

2. The method according to claim 1, wherein said plurality of computing systems are healthcare systems employing at least one of Electronic Health Record (EHR) software applications and Electronic Medical Record (EMR) software applications.

3. The method according to claim 1, further comprising automatically interpreting, by said second computing system, said information contained in said template, whereby said first and second computing systems are syntactically and semantically interoperable.

4. The method according to claim 1, further comprising receiving, at said first computing system, user-specified metadata.

5. The method according to claim 1, further comprising communicating said user-specified metadata from said first computing system to said second computing system.

6. The method according to claim 1, further comprising receiving, at said first healthcare system, a second user input selecting an identifier for said template.

7. The method according to claim 6, wherein said template is automatically completed in response to said second user input.

8. The method according to claim 1, further comprising:
receiving, at said first computing system, a second user input selecting a virtual device from a plurality of devices; and
receiving, at said first computing system, at least one third user input for configuring said virtual device.

9. The method according to claim 8, wherein said virtual device is a virtual printer configured for using said plurality of pre-defined templates.

10. The method according to claim 9, wherein said virtual device is selected using a graphical user interface that is accessible via a “Print” command of an application window.

11. A system for providing interoperability between a plurality of computing systems employing software applications implementing a plurality of different standards, comprising:
at least one processing device comprising a memory having stored thereon instructions, which when executed by said processing device, cause said processing device to perform the following operations comprising:
generating an electronic document having a first data structure;
receiving a first user input selecting a computing system of said plurality of computing systems that is to receive data contained in said electronic document;
automatically selecting at least one template from a plurality of pre-defined templates based on said first user input, said template having a second data structure that is different than said first data structure and with which said computing system is compatible;
automatically completing said template using at least a portion of said data contained in said electronic document;
automatically obtaining pre-defined metadata specifying at least a meaning of information contained in said template and an intended use of said information; and
forwarding said pre-defined metadata and said template to an interface for communication to said computing system.

12. The system according to claim 11, wherein said plurality of computing systems are healthcare systems employing at least one of Electronic Health Record (EHR) software applications and Electronic Medical Record (EMR) software applications.

13. The system according to claim 11, wherein said computing system is configured for automatically interpreting said information contained in said template.

14. The system according to claim 11, wherein said processing device is further caused to receive user-specified metadata.

15. The system according to claim 14, wherein said user-specified metadata is communicated from said processing device to said second computing system.

16. The system according to claim 11, wherein said processing device is further caused to receive a second user input selecting an identifier for said template.

17. The system according to claim 16, wherein said template is automatically completed in response to said second user input.

18. The system according to claim 11, wherein said processing device is further caused to:
receive a second user input selecting a virtual device from a plurality of devices; and
receive at least one third user input for configuring said virtual device.

19. The system according to claim 18, wherein said virtual device is a virtual printer configured for using said plurality of pre-defined templates.

20. The system according to claim 19, wherein said virtual device is selected using a graphical user interface that is accessible via a “Print” command of an application window.
